(19) United States
(12) Patent Application Publication
(10) Pub. No.: US 2020/0184786 A1
(43) Pub. Date: Jun. 11, 2020

(54) Alert Device for the Disturbance of an Object

(71) Applicants: Nathan Lawrence Ackerman, Hancock, MI (US); Bryan Laroy Ackerman, Freeland, MI (US)

(72) Inventors: Nathan Lawrence Ackerman, Hancock, MI (US); Bryan Laroy Ackerman, Freeland, MI (US)

(21) Appl. No.: 16/214,086

(22) Filed: Dec. 9, 2018

(51) Int. Cl. G08B 13/14; G08B 15/00

(52) U.S. Cl. CPC G08B 13/14; G08B 15/00

(57) ABSTRACT

A detection and alert system designed for use in the wilderness in order to alert the owner when their provision container is disturbed and provides an alarm to scare away whatever is disturbing the container. The device incorporates a disturbance detection method via either a contact or non-contact method. The alarm of the device preferably consists of a bright light, and/or an audible sound that is intense enough to deter the entity disturbing the container. The device may also be paired to the owners Bluetooth enabled smartphone to receive an alert of the disturbance.

### CROSS-REFERENCE TO RELATED APPLICATIONS

| | | |
|---|---|---|
| 7,579,949 | August, 2009 | Chiu |
| 7,586,409 | September, 2009 | Armstrong |
| 7,598,861 | October, 2009 | Belden, Jr. |
| 7,608,812 | October, 2009 | Beinhocker |
| 7,675,413 | March, 2010 | Watts |
| 7,782,199 | August, 2010 | Issokson |
| 7,924,154 | April, 2011 | Belden, Jr. |
| 5,831,531 | November, 1998 | Tuttle |
| 5,646,592 | July, 1997 | Tuttle |
| 5,434,559 | July, 1995 | Smiley |
| 8,432,281 | April, 2013 | Reese |
| 8,997,680 | April, 2015 | Gardner |
| 7,268,689 | September, 2007 | Sulaver |
| 6,433,692 | August 2002 | Kenum |

### BACKGROUND OF THE INVENTION

When enjoying the outdoors for long periods of time it is necessary to bring provisions such as food into the wilderness. However, bringing food out into the wild can attract unwanted wildlife such as raccoons or bears. It is common for people to use devices such as “bear canisters” to deter or encumber wildlife from reaching the food. These typically comprise of cylindrical containers with a screw or latched top.

These canisters are however not scent proof. Bears are known to have a sense of smell six times better than the best dogs. Wildlife in the area can be attracted to the canister, putting the contents at risk. Manufacturers of these devices recommend that the canister be placed roughly 30 feet from the camp site where the owner is sleeping. The idea behind the canisters is that the owner of the canister should be able to hear the animal trying to access the food and can then scare the animal off. The problem lies in the fact that if the owner of the canister does not hear the animal and scare it away, the animal can either take the canister or with enough time break into the canister. In either situation, the owner is left with no food.

### BRIEF SUMMARY OF THE INVENTION

This invention aims to provide an automatic detection system that alerts the owner of the container that the container has been moved, as well as sensory aspects meant to scare away the wildlife that is disturbing the container. This is substantially better than the widely practiced method of leaving cookware on top of the container to make noise. The invention will be in physical contact with the container, either below, on top, or alongside of the container to detect when the container is disturbed. The device may also detect the disturbance of the container or containers via non-contact methods such as sonar or ultrasonic devices. The device, when triggered will emit deterrents to the wildlife such as a bright light, and/or audible noise which will alert the owner as well as frighten the wildlife away from the container. Furthermore, the device can be paired to the owner's cell phone, so that the owner can set up a personal alert on the cell phone which can be safely located in the tent with the owner.

### BRIEF DESCRIPTION OF THE SEVERAL VIEWS OF THE DRAWING

FIG. 1A is front view of the alert device with the spring loaded switch activated.

FIG. 1B is a cross-sectional right side view of the alert device of FIG. 1A.

FIG. 1C is a cross sectional top view of the alert device of FIG. 1A.

FIG. 2A is a front view of the alert device with the spring loaded switch in the stored position.

FIG. 2B is a cross-sectional right side view of the alert device of FIG. 2A with the spring loaded switch in the stored position.

FIG. 3A is a front view of the alert device with a typical food canister placed on top and the spring loaded switch in the stored position.

FIG. 3B is a cross sectional right side view of the alert device of FIG. 3A with a typical food canister placed on top and the spring loaded switch in the stored position.

FIG. 4A is a front view of the alert device with a typical food canister on top.

FIG. 4B is a cross-sectional right side view of the alert device of FIG. 4A with a typical food canister on top.

FIG. 4C is a cross sectional right side view of the alert device of FIG. 4A with a typical food canister beginning to lift off the device, allowing the spring loaded switch to begin swinging upward.

FIG. 4D is a cross sectional right side view of the alert device of FIG. 4A with a typical food canister completely separated from the device, allowing the spring loaded switch to move to the activated position.

FIG. 5 is a top view of the device, shown using the non-contact method of disturbance detection.

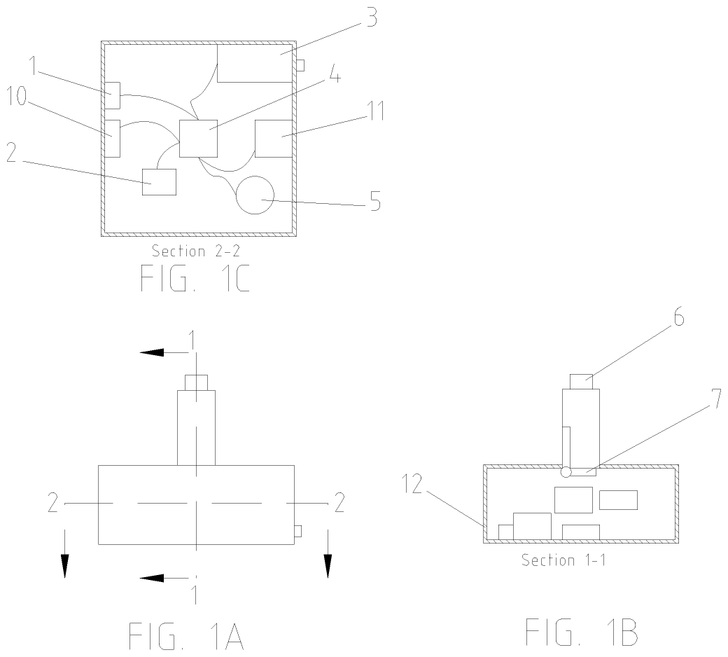

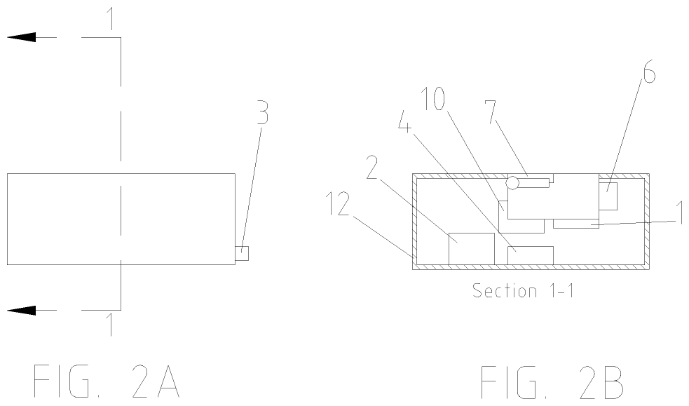

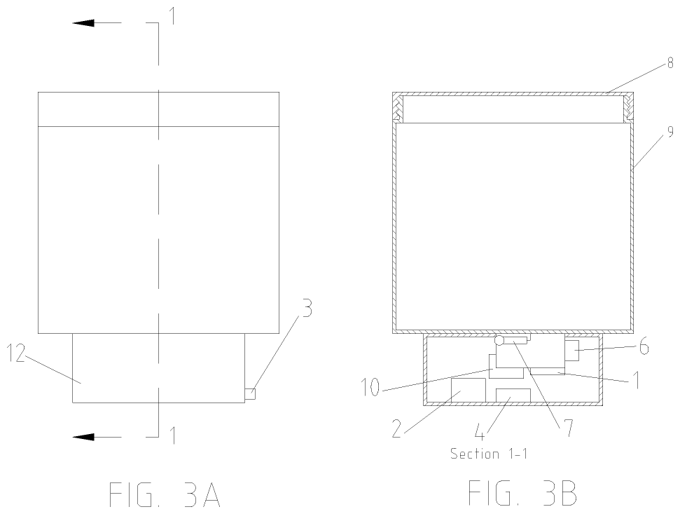

### DETAILED DESCRIPTION OF THE INVENTION

The invention is a battery powered device which is in physical contact with a container or placed near the container, in which the device can detect disturbance of the container such as it being tilted, picked up, or knocked over. The device can sense this motion of the container using any number of commercially available devices such as a limit switch, float switch, or ultrasonics. Upon sensing the disturbance, an alarm which can include a light or emitted sound, are produced at frequency and intensity to wake the owner and be a deterrent to the wildlife. Furthermore, an alert can be sent to the owners paired Bluetooth enabled smartphone.

When referencing drawings, parts are typical throughout drawings and part numbers are consistent throughout all drawings. The device is preferably made of a plastic housing (Part 12); battery (Part 11); the circuit board to control the device (Part 4); electronics for movement detection; a light (Part 6): an audible sound generator (Part 5); and a Bluetooth or similar networking device (Part 2). The device is placed on, under, next to, or strapped to the side of, the provision container.

The electronics for movement detection may consist of a spring loaded switch (Part 7) to detect when the device has physically separated from the container; or a trigger such as a float switch or gyro (Part 1) to determine when the container has changed orientation or is in motion. The device may incorporate an ultrasonic sensor (Part 10) to detect when an object that it is not in contact with moves or is moved.

Once triggered, the electronics of the device will activate the alarm consisting of a bright light (Part 6); preferably a Light Emitting Diode (LED), which will illuminate the surrounding area, preferably in a flashing or strobing pattern. The alarm will also emit a loud audible noise via simple speaker or sound emitting device (Part 5) The device could also send an alert to a Bluetooth connected device.

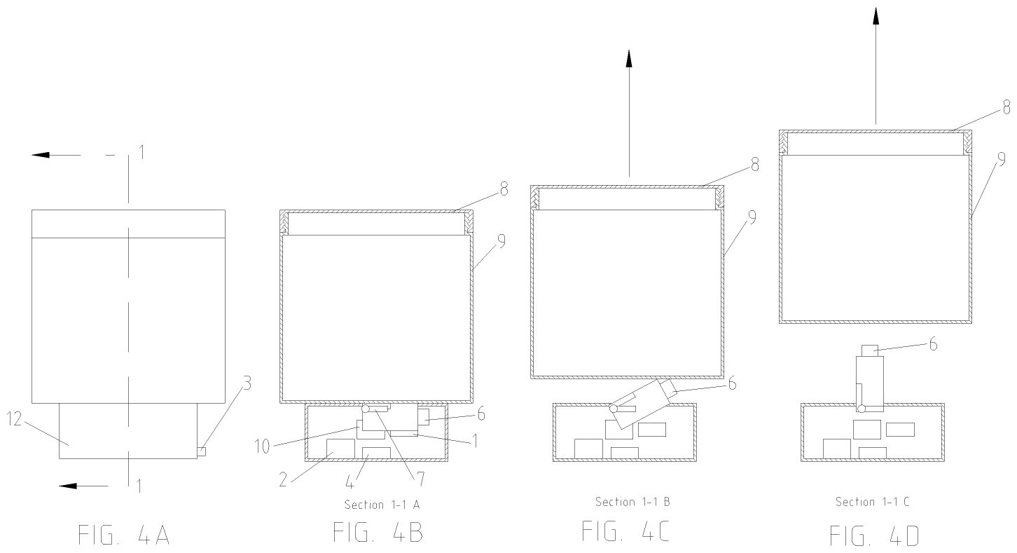

FIGS. 4A, 4B, 4C, and 4D show a progression of views of a typical food canister being lifted off the device. The canister pictured consists of a cylindrical body (Part 9) and a threaded, screw-on lid (Part 10). As the canister is lifted off, the spring loaded switch is allowed to move upward. The spring loaded switch is connected to the LED light, allowing the LED light to follow the free end of the spring loaded switch. When the spring loaded switch and light reaches a set angle, the switch will close and activate the alert system.

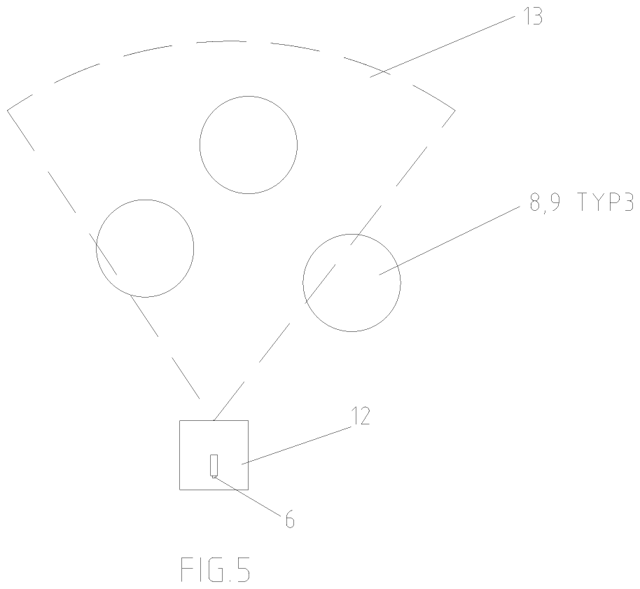

FIG. 5 shows a top view of the device using a non-contact method of disturbance detection. Containers can be placed in the field of view (Part 13) of an ultrasonic sensor. When a container or anything in the field of view moves, the device is triggered and the alarm is activated.

1. A battery powered device that detects the disturbance of a container that is placed in contact with it, wherein the device is comprised of a housing and control circuit; wherein the control circuit consists of a motion detector and alarm unit; wherein the motion detector is a spring loaded switch and will activate the alarm of the device when the container is removed from contact with the device.

2. The device of claim 1, wherein the alarm is an audible sound.

3. The device of claim 1, wherein the alarm is a light.

4. The device of claim 1, wherein the alarm function is the release of scent.

5. The device of claim 1, wherein the device includes a networking function that can connect to other devices.

6. A battery powered device that detects the disturbance of a container that is placed within the device's range, wherein the device is comprised of a housing and control circuit; wherein the control circuit consists of a motion detector, microprocessor, and alarm unit; wherein the motion detector is an ultrasonic sensor and will activate the alarm of the device when a container is moved while in range of the device.

7. The device of claim 6, wherein the alarm is an audible sound.

8. The device of claim 6, wherein the alarm is a light.

9. The device of claim 6, wherein the alarm function is the release of scent

10. The device of claim 6, wherein the device includes a networking function that can connect to other devices.
